(19) United States
(12) Patent Application Publication
(10) Pub. No.: US 2025/0210806 A1
(43) Pub. Date: Jun. 26, 2025

(54) ION SELECTIVE LAYERS AND APPLICATIONS THEREOF

(71) Applicant: URBAN ELECTRIC POWER INC., Pearl River, NY (US)

(72) Inventors: Jinchao HUANG, Pearl River, NY (US); Gautam G. YADAV, Pearl River, NY (US); Meir WEINER, Pearl River, NY (US); Sanjoy BANERJEE, Pearl River, NY (US)

(21) Appl. No.: 18/849,924

(22) PCT Filed: Mar. 24, 2023
(86) PCT No.: PCT/US2023/016246

§ 371 Date: Sep. 23, 2024

Related U.S. Application Data
(60) Provisional application No. 63/323,464, filed on Mar. 24, 2022.

(51) Int. Cl. H01M 50/414; H01M 4/02; H01M 4/38; H01M 4/48; H01M 6/04; H01M 10/28

(52) U.S. Cl. CPC H01M 50/414; H01M 4/38; H01M 4/48; H01M 6/045; H01M 10/28; H01M 2004/027; H01M 2004/028; H01M 2300/0014

(57) ABSTRACT

An ion selective layer includes a water-soluble organic polymer, a cross-linker, a water-soluble inorganic salt or hydroxide, and water. A method of making the ion selective layer includes dissolving a water-soluble organic polymer in water, dissolving a water-soluble inorganic salt or hydroxide in water, dissolving a cross-linker in water, cross-linking the water-soluble polymer, forming a layer by casting onto a substrate, and drying the water solution to form a film. Another method of making the ion selective layer includes dissolving a water-soluble organic monomer in water, dissolving a water-soluble inorganic salt or hydroxide in water, dissolving a cross-linker in water, dissolving an initiator in water, polymerizing and cross-linking the water-soluble monomer, forming a layer by casting onto a substrate, and drying the water solution to form a film.

### CROSS-REFERENCE TO RELATED APPLICATIONS

This application claims the benefit of U.S. Provisional Application No. 63/323,464 filed on Mar. 24, 2022 and entitled, “ION SELECTIVE LAYERS AND APPLICATIONS THEREOF,” which is incorporated herein by reference in its entirety for all purposes.

### BACKGROUND

Currently, there is the recognition that the alkaline zinc manganese dioxide (Zn/MnO₂) battery chemistry can be a strong candidate solution for energy storage due to its low cost, abundant raw materials, safety characteristics, and high theoretical energy density. However, the full energy accessibility as well as its rechargeability have long been a concern for this battery chemistry. While dominating the primary battery market, the accessible MnO₂ capacity in a commercial primary battery is limited to its 1-electron reduction. For a rechargeable alkaline Zn-MnO₂ battery, a long cycle life was only achievable by limiting the utilizations of the active materials (typically 10%-20% of MnO₂ 1-electron and<10% of Zn 2-electron capacity (where the 2^{nd} electron capacity is about 617 mAh/g of MnO2)). Accessing higher DOD leads to detrimental phase transformation of the MnO₂ and zinc redistribution problem.

### SUMMARY

In some embodiments, an ion selective layer comprises a water-soluble organic polymer, a cross-linker, a water-soluble inorganic salt or hydroxide, and water.

In some embodiments, a method of making the ion selective layer comprises dissolving a water-soluble organic polymer in water, dissolving a water-soluble inorganic salt or hydroxide in water, dissolving a cross-linker in water, cross-linking the water-soluble polymer, forming a layer by casting onto a substrate, and drying the water solution to form a film.

In some embodiments, a method of making the ion selective layer comprises dissolving a water-soluble organic monomer in water, dissolving a water-soluble inorganic salt or hydroxide in water, dissolving a cross-linker in water, dissolving an initiator in water, polymerizing and cross-linking the water-soluble monomer, forming a layer by casting onto a substrate, and drying the water solution to form a film.

In some embodiments, an alkaline battery comprises an anode, a cathode, an electrolyte, and an ion selective layer disposed between the anode and the cathode. The ion selective layer comprises a water-soluble organic polymer, a cross-linker, a water-soluble inorganic salt or hydroxide, and water.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A-1C illustrate various batteries according to some embodiments.

FIG. 2 is a graph illustrating the ionic conductivities and zinc ion permeabilities through PVA and cross-linked PVA layers.

FIG. 3 is a graph illustrating specific charge and discharge capacities of cells with PVA and cross-linked PVA layers.

FIG. 4 is a graph illustrating specific charge and discharge capacities of cells with and without a cross-linked polyacrylate-KOH-H₂O layer.

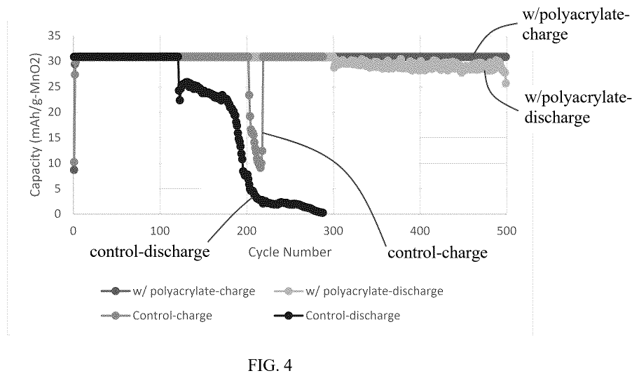

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

Recently, a birnessite (δ-MnO₂) material stabilized by Cu²⁺ has been reported to deliver near-full two-electron capacity for more than 6,000 cycles in the absence of zinc. However, when a zinc anode was used, the cell still showed energy fade due to the formation of ZnMn₂O₄. Additionally, a short-circuit problem is occasionally observed after cycling such a birnessite-Zn cell as the Zn dendrites tend to penetrate the separator and the dissolved copper ions tend to migrate and deposit on the anodes. Therefore, inhibiting the spinel phase formation and preventing the short-circuit problem remain major challenges for both achieving higher capacity of a primary Zn/MnO₂ battery, and long-term cycling of an energy-dense secondary Zn/MnO₂ battery.

The present disclosure relates to methods for making highly conductive and stable ion selective layers containing cross-linked water-soluble organic polymers. Applications of such ion selective layers in primary and rechargeable alkaline batteries are described.

In some embodiments, a method of forming a dry layer with cross-linked water-soluble organic polymers is disclosed. The method includes selecting a water-soluble organic polymer as the matrix and a cross-linker for the ion selective layer. The method further includes dispersing the polymer and cross-linker homogeneously in water. The method further includes cross-linking the polymers and forming a dry film after air drying. This layer can be a free-standing layer that can be applied as a film or sheet within a cell. The layer is highly conductive, highly selective and mechanically, chemically and electrochemically stable in alkaline solutions.

In some embodiments, a method of forming an electrolyte impregnated layer with crosslinked water-soluble organic polymer is disclosed. The method includes selecting a water-soluble organic polymer as the matrix, a salt or a hydroxide or mixtures as the electrolyte and a cross-linker. The method further includes dispersing the polymer, the salt and/or the hydroxide, and the crosslinker homogeneously in water. The method further includes crosslinking the polymers. The method further includes casting a layer on a substrate with the solution and drying it to the desired water content. The dried layer can be a freestanding layer, film, or sheet that can be incorporated into a cell. The layer is high conductive, highly selective, and mechanically, chemically, and electrochemically stable in alkaline solutions.

In some embodiments, a method of forming an electrolyte impregnated layer with crosslinked water-soluble organic polymer from a water-soluble monomer is disclosed. The method includes selecting a water-soluble organic monomer, an initiator, a salt or a hydroxide or mixtures as the electrolyte and a cross-linker. The method further includes dispersing the monomer, the initiator, the salt, or the hydroxide and the crosslinker homogeneously in water. The method further includes polymerizing the monomers and crosslinking the polymers. The method further includes casting a layer on a substrate with the solution and drying it to the desired water content. The dried layer can be a freestanding layer, film, or sheet that can be incorporated into a cell. The layer is high conductive, highly selective, and mechanically, chemically, and electrochemically stable in alkaline solutions.

In an embodiment, this disclosure features a method for making a battery comprising a cathode, an anode, a separator and at least one layer of the ion selective layer disposed between the anode and the cathode. These and other features will be more clearly understood from the following detailed description taken in conjunction with the accompanying drawings and claims.

The work described in this disclosure mainly relates to highly conductive and stable ion selective layers containing cross-linked water-soluble organic polymers that mitigates the zinc and copper migration and prevents early capacity fade due to active material deterioration and short circuit.

Poly(vinyl alcohol) (PVA), polyacrylates and poly(ethylene glycol) are water-soluble organic polymers that have been widely used in various industrial applications. These polymers are cheap, environmentally benign, and easily manufacturable. They are highly hydrophilic, ionically conductive, and stable in alkaline electrolytes. Cross-linking of these polymers are usually introduced to improve the mechanical stability and oxidation resistance. Cross-linking also improves the ion selectivity of the polymer layers and mitigates the transport of large ions such as the zinc and copper ions. This is because smaller OH⁻ ions tend to move freely in the electrolyte-swollen polymer matrix, while the movement of bulkier hydrated zinc or copper ions is hindered by the randomly entangled polymer chains. Cross-linking can be done by electron beam or γ-irradiation, or by using crosslinking agents such as monoaldehydes and dialdehydes.

The present methods and separators can be used in cells including but not limited to alkaline Zn-MnO₂, Zn-NiOOH, Zn-air, Zn-Cu, Zn-carbon, and Zn-Ag₂O cells. In addition, both primary and secondary battery cells may be used, and both prismatic and cylindrical cells may be used. The layers may be present as a dried film or layer that is freestanding. The layer can be hydrated within the cell upon introduction of one or more electrolytes (e.g., a single electrolyte, an anolyte and catholyte, etc.) into the cell.

In some embodiments, an ion selective layer comprises a water-soluble organic polymer, a cross-linker, a water-soluble inorganic salt or hydroxide, and water. The water-soluble organic polymer can be poly(vinyl alcohol), poly(acrylic acid), poly(ethylene glycol), polyacrylamide, cellulose, poly(methacrylic acid), or combinations thereof. The water-soluble organic polymer can be cross-linked. For example, the water-soluble organic polymer can be cross-linked with a crosslinker such as an organic dialdehyde, N,N′methylene-bisacrylamide, boric acid, sodium borate or combinations thereof. The water-soluble organic polymer can have an average molecular weight of 500 to 200,000 Da. The weight ratio of water to the water-soluble organic polymer can be in the range of 0 to 10. The weight ratio of the water-soluble inorganic salt or hydroxide to the water-soluble organic polymer can be in the range of 0 to 10. The weight ratio of water to the water-soluble inorganic salt or hydroxide can be in the range of 0 to 20. The weight ratio of crosslinker to the water-soluble organic polymer can be in the range of 0.0001 to 0.1. The water-soluble inorganic salt or hydroxide can be potassium carbonate, sodium carbonate, potassium sulfate, sodium sulfate, potassium chloride, sodium chloride, potassium fluoride, sodium fluoride, potassium hydroxide, sodium hydroxide, lithium hydroxide or combinations thereof. The thickness of the layer can range from 10 μm to 10 mm, for example the thickness of the layer can be measured once the layer is at least partially dried. The layer can be a freestanding layer that is self-supporting and is used as a layer or film in the cell.

A method of making an ion selective layer can comprise dissolving a water-soluble organic polymer in water, dissolving a water-soluble inorganic salt or hydroxide in water, dissolving a cross-linker in water, cross-linking the water-soluble polymer, forming a layer by casting the cross-linked water soluble polymer with the other components onto a substrate, and drying the solution to a desired water content. In some aspects, the solution can be dried to form a freestanding layer or film. Another method of making an ion selective layer can comprise dissolving a water-soluble organic monomer in water, dissolving a water-soluble inorganic salt or hydroxide in water, dissolving a cross-linker in water, dissolving an initiator in water, polymerizing and cross-linking the water-soluble monomer, forming a layer by casting onto a substrate, and drying the water solution to desired water content. The organic polymer can be dissolved in water under rigorous stirring at temperatures ranging from 20-100° C. The organic monomer can be dissolved in water under rigorous stirring at temperatures ranging from 20-100° C. The ion selective layer can be air dried at temperatures ranging from 20-100° C. The initiator can be peroxides or aliphatic azo compounds or combinations thereof. The ion selective layer can be produced as a freestanding film or layer that can be incorporated into a battery during formation and production of the battery.

An alkaline battery can comprise an anode, a cathode, an electrolyte, and a separator disposed between the anode and the cathode. The battery can be a primary battery or a secondary battery (i.e., a rechargeable battery). The separator can comprise at least one ion selective layer as described herein. The ion selective layer can be applied alone or combined with one or more non-selective separator membranes. The non-selective membranes can be nonwovens or polymer films fabricated from nylon, polyester, polyethylene, polypropylene, poly(tetrafluoroethylene)(PTFE), poly(vinyl chloride) (PVC), polyvinyl alcohol, cellulose and combinations thereof. The anode can be zinc, lithium, aluminum, magnesium, iron, cadmium, or a combination thereof. The cathode can be metal oxide or metal hydroxide of manganese, nickel, silver, lead, copper, or combinations thereof. The electrolyte can be solution of potassium hydroxide, sodium hydroxide, lithium hydroxide and combinations thereof, with a concentration between 5-50 wt %.

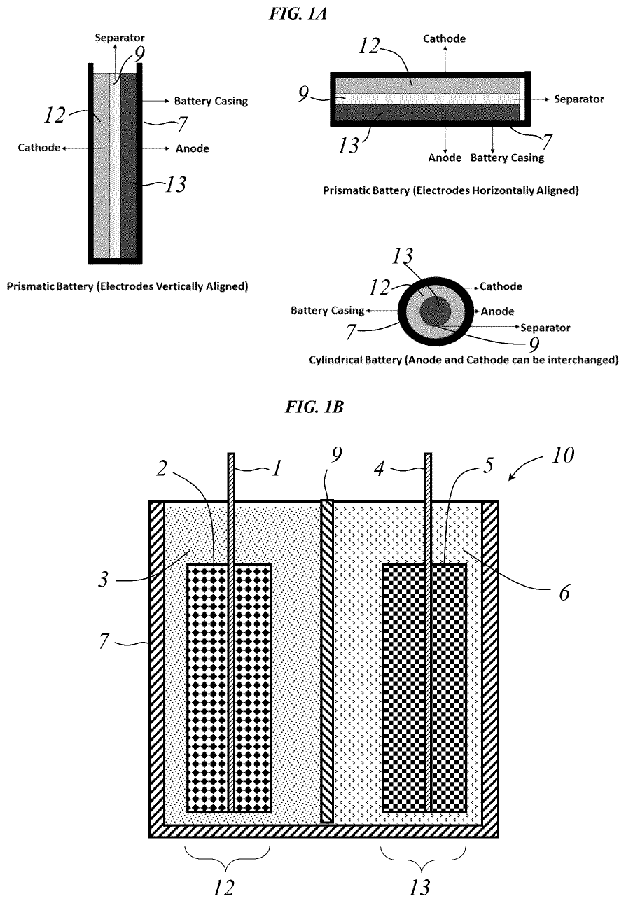

Referring to FIGS. 1A-1C, a battery 10 can have a housing 7, a cathode 12, which can include a cathode current collector 1 and a cathode material 2, and an anode 13. In some embodiments, the anode 13 can comprise an anode current collector 4, and an anode material 5. It is noted that the scale of the components in FIGS. 1A-1C may not be exact as the features are illustrated to clearly show the electrolyte around the anode 13 and the cathode 12. FIGS. 1A-1B generally illustrate a prismatic battery arrangement having a single anode 13 and cathode 12. In another embodiment, the battery can be a cylindrical battery having the electrodes arranged concentrically (FIG. 1A) or in a rolled configuration (FIG. 1C) in which the anode 13 and cathode 12 are layered and then rolled to form a jelly roll configuration. The cathode current collector 1 and cathode material 2 are collectively called either the cathode 12 or the positive electrode 12, as shown in FIG. 1B. Similarly, the anode material 5 with the optional anode current collector 4 can be collectively called either the anode 13 or the negative electrode 13. An electrolyte can be in contact with the cathode 12 and the anode 13. As described in more detail herein, the electrolyte 3,6 in contact with both the cathode 12 and the anode 13 can be substantially the same; or alternatively, different electrolyte compositions can be used with the anode 13 and the cathode 12 to modify the properties of the battery 10 in some embodiments.

In some embodiments, the battery 10 can comprise one or more cathodes 12 and one or more anodes 13, which can be present in any configuration or form factor. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyroll configuration (e.g., as shown in FIG. 1C), the battery 10 may only have one cathode 12 and one anode 13 in a rolled configuration such that a cross section of the battery 10 includes a layered configuration of alternating electrodes, though a plurality of cathodes 12 and anodes 13 can be used in a layered configuration and rolled to form the rolled configuration with alternating layers.

In an embodiment, housing 7 comprises a molded box or container that is generally non-reactive with respect to the electrolyte solutions in the battery 10, including the electrolyte. In an embodiment, the housing 7 comprises a polymer (e.g., a polypropylene molded box, an acrylic polymer molded box, etc.), a coated metal, or the like.

In some embodiments, the cathode can comprise an electroactive material comprising a metal oxide or a metal hydroxide of manganese, nickel, silver, lead, copper or combinations thereof. In some aspects, the cathode 12 can be manganese dioxide. The manganese dioxide can be of various polymorphs like electrolytic manganese dioxide (EMD), α-MnO₂, β-MnO₂, γ-MnO₂, δ-MnO₂, ε-MnO₂, or λ-MnO₂. Other forms of MnO₂ can also be present such as hydrated MnO₂. pyrolusite, birnessite, ramsdellite, hollandite, romanechite, todorokite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄, Li₂MnO₃), CuMn₂O₄, aluminum manganese oxide, zinc manganese dioxide, bismuth manganese oxide, copper intercalated birnessite, copper intercalated bismuth birnessite, tin doped manganese oxide, magnesium manganese oxide, or any combination thereof. In some aspects, the cathode 12 can, but is not limited to, manganese dioxide, copper manganese oxide, hausmannite, manganese oxide, copper intercalated bismuth birnessite, birnessite, todokorite, ramsdellite, pyrolusite, pyrochroite, silver oxide, silver dioxide, silver, nickel oxyhydroxide, nickel hydroxide, nickel, lead oxide, copper oxide, copper dioxide, lead, lead dioxide (α and β), silver permanganate, lithium nickel manganese cobalt oxide, sulfur, lithium iron phosphate, lithium copper oxide, lithium copper oxyphosphate, or any combination thereof.

In general, the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles. For example, a full or partial discharge to the end of the MnO₂ second electron stage (e.g., between about 20% to about 100% of the 2^{nd} electron capacity of the cathode, or alternatively between about 50% to about 100% of the 2^{nd} electron capacity of the cathode) may be performed and subsequently recharging back to its Mn⁴⁺ state, resulting in birnessite-phase manganese dioxide. Combinations of electroactive materials can also be employed in the cathode materials 2. The electroactive cathode materials 2 can be in the form of powders of varying particle sizes (nanometers to micrometers) and/or in the form of metallic substrates with planar, mesh or perforated-type architecture.

The cathode 12 can comprise a mixture of components including an electrochemically active material (e.g., cathode electroactive material). Additional components such as a binder, a conductive material, and/or one or more additional components can also be optionally included that can serve to improve the lifespan, rechargeability, and electrochemical properties of the cathode 12. The cathode can comprise between about 1 wt. % and about 95 wt. % active material, alternatively between about 1 wt. % and about 90 wt. % active material, or alternatively between about 50 wt. % and about 90 wt. % active material.

The addition of a conductive additive such as conductive carbon enables high loadings of an electroactive material in the cathode material, resulting in high volumetric and gravimetric energy density. In some embodiments, the conductive additive can be present in the cathode material 2 in an amount of about 1-90 wt. %, alternatively about 1-50 wt. %, alternatively about 10-50 wt. %, or alternatively about 1-30 wt. %, based on the total weight of the cathode material 2. Nonlimiting examples of conductive carbon suitable for use in the present disclosure as a conductive additive include single walled carbon nanotubes, multi-walled carbon nanotubes, graphene, carbon blacks of various surface areas, any other suitable conductive carbon that specifically has relatively very high surface area and conductivity, or any combination thereof. In some embodiments, the conductive additive can comprise graphite, carbon fiber, carbon black, acetylene black, single walled carbon nanotubes, multi-walled carbon nanotubes, nickel or copper coated carbon nanotubes, dispersions of single walled carbon nanotubes, dispersions of multi-walled carbon nanotubes, graphene, graphyne, graphene oxide, or a combination thereof. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), Zenyatta graphite, and/or combinations thereof.

The total conductive additive mass percentage (e.g., total carbon mass percentage) in the cathode material 2 can range from about 1% to about 99%, alternatively from about 5% to about 99%, alternatively from about 1% to about 90%, alternatively from about 1% to about 50%, alternatively from about 5% to about 99%, alternatively from about 10% to about 80%, or alternatively from about 10% to about 50%. In some embodiments, the electroactive component in the cathode material 2 can be between 1 and 99 wt. % of the weight of the cathode material 2, and the conductive additive can be between 1 and 99 wt. % of the weight of the cathode material 2.

In some embodiments, the cathode material 2 can also comprise a conductive component. The addition of a conductive component such as metal additives to the cathode material 2 may be accomplished by addition of one or more metal powders such as nickel powder to the cathode material 2. The conductive metal component can be present in a concentration of between about 0-30 wt. % in the cathode material 2. The conductive metal component may be, for example, nickel, copper, silver, gold, tin, cobalt, antimony, brass, bronze, aluminum, calcium, iron, or platinum. In one embodiment, the conductive metal component is a powder. In some embodiments, the conductive component can be added as an oxide and/or salt. For example, the conductive component can be cobalt oxide, cobalt hydroxide, lead oxide, lead hydroxide, or a combination thereof. In some embodiments, a second conductive metal component is added to act as a supportive conductive backbone for the first and second electron reactions to take place. The second electron reaction has a dissolution-precipitation reaction where Mn³⁺ ions become soluble in the electrolyte and precipitate out on the materials such as graphite resulting in an electrochemical reaction and the formation of manganese hydroxide [Mn(OH)₂] which is non-conductive. This ultimately results in a capacity fade in subsequent cycles. Suitable conductive components that can help to reduce the solubility of the manganese ions include transition metals like Ni, Co, Fe, Ti and metals like Ag, Au, Al, Ca. Oxides and salts of such metals are also suitable. Transition metals like Co can also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% conductive component (e.g., a conductive metal), and 1-10% binder.

In some embodiments, dopants or additives can be added to the cathode material 2, as necessary to enhance rechargeability and performance. The additives can be in the form of powders mixed with the electroactive material or in the form of metallic substrates onto which the electroactive and conductive carbon can be pasted onto. Nonlimiting examples of additives suitable for use in the electrode materials of this disclosure include bismuth, bismuth oxide, copper oxide, copper, indium, indium hydroxide, indium oxide, aluminum, aluminum oxide, nickel, nickel hydroxide, nickel oxide, silver, silver oxide, cobalt, cobalt oxide, cobalt hydroxide, lead, lead oxide, lead dioxide, quinones, salts thereof, derivatives thereof, or any combination thereof. In some embodiments, the dopants or additives can be present in the cathode material 2 in an amount between 0 to 30 wt. %, based on the total weight of the cathode material 2.

The cathode material 2 can comprise additional elements, such as dopants or additives. The additional elements can be included in the cathode material including a bismuth/bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long-term performance with the copper and bismuth incorporated into the crystal and nanostructure of the birnessite.

The bismuth or bismuth-based compounds can be used in the cathode material 2 to access relatively greater capacity (e.g., 50-100%) from the manganese dioxide 2^{nd} electron capacity. The bismuth or bismuth-based compounds can be used in batteries where manganese dioxide is usually the layered-phase birnessite. The bismuth or bismuth-based compounds can also be used in batteries where the manganese dioxide can be any polymorph and wherein discharging it completely to 617 mAh/g and charging it back results in the formation of birnessite.

The bismuth compound can be incorporated into the cathode 12 as an inorganic or organic salt of bismuth (oxidation states 5, 4, 3, 2, or 1), as a bismuth oxide, or as bismuth metal (i.e., elemental bismuth). The bismuth compound can be present in the cathode material at a concentration between about 1-20 wt. % of the weight of the cathode material 2. Examples of bismuth compounds include bismuth oxide, bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yttria stabilized (e.g., yttria doped bismuth oxide), bismuth-lead alloy, ammonium bismuth citrate, 2-napthol bismuth salt, dichloritri(o-tolyl)bismuth, dichlorodiphenyl(p-tolyl)bismuth, triphenylbismuth, and/or combinations thereof.

The copper or copper-based compounds can be used in the cathode material 2 to access relatively greater capacity (e.g., 50-100%) from the manganese dioxide 2^{nd} electron capacity. The copper or copper-based compounds can be used in batteries where manganese dioxide is usually the layered-phase birnessite. The copper or copper-based compounds can also be used in batteries, wherein the manganese dioxide can be any polymorph and discharging it completely to 617 mAh/g and charging it back results in the formation of birnessite. It is advantageous to use copper or copper-based compounds in batteries accessing 50-100% of the 617 mAh/g for thousands of cycles, as Cu helps in the rechargeability and with reducing the charge transfer resistance.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt. % of the weight of the cathode material 2. In some embodiments, the copper compound is present in a concentration between about 5-50 wt. % of the weight of the cathode material 2. In other embodiments, the copper compound is present in a concentration between about 10-50 wt. % of the weight of the cathode material 2. In yet other embodiments, the copper compound is present in a concentration between about 5-20 wt. % of the weight of the cathode material 2. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full or nearly full reversibility during galvanostatic cycling, as compared to a bismuth-modified MnO₂ which cannot withstand galvanostatic cycling as well.

In some embodiments, the copper can be used in the cathode material 2 in powder form, metallic form fabricated as a mesh, foil, wire, ingot, or any suitable shape and/or form.

In some embodiments, a binder can be used with the cathode material 2. The binder can be present in a concentration of between about 0-10 wt. %, or alternatively between about 1-5 wt. % by weight of the cathode material. In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % carboxymethyl cellulose (CMC) solution cross-linked with 0-10 wt. % polyvinyl alcohol (PVA) on an equal volume basis. The binder, compared to the traditionally-used TEFLON® or PTFE (polytetrafluoroethylene), shows superior performance. TEFLON® or PTFE is a very resistive material, but its use in the industry has been widespread due to its good rollable properties. This, however, does not rule out using TEFLON® or PTFE as a binder. In some embodiments, TEFLON® can be used as a binder. Mixtures of TEFLON® or PTFE with the aqueous binder and some conductive carbon can be used to create rollable binders. Using the aqueous-based binder can help in achieving a significant fraction of the two-electron capacity with minimal capacity loss over many cycles. In some embodiments, the binder can be water-based, have superior water retention capabilities, adhesion properties, and help to maintain the conductivity relative to an identical cathode using a PTFE binder instead. Examples of suitable water-based hydrogels (e.g., water-soluble cellulose-based hydrogels) can include, but are not limited to, methyl cellulose (MC), carboxymethyl cellulose (CMC), hydroypropyl cellulose (HPH), hydroypropylmethyl cellulose (HPMC), hydroxyethylmethyl cellulose (HEMC), carboxymethylhydroxyethyl cellulose, hydroxyethyl cellulose (HEC), and combinations thereof. Examples of crosslinking polymers (e.g., conductive polymers) include polyvinyl alcohol, polyvinylacetate, polyaniline, polyvinylpyrrolidone, polyvinylidene fluoride, polypyrrole, and combinations thereof. In some embodiments, a 0-10 wt. % solution of water-cased cellulose hydrogen can be cross-linked with a 0-10 wt. % solution of crosslinking polymers by, for example, repeated freeze/thaw cycles, radiation treatment, and/or chemical agents (e.g., epichlorohydrin). The aqueous binder may be mixed with 0-5% PTFE to improve manufacturability. In some embodiments, polyvinyl alcohol (PVA) can be used as a binder by itself.

The resulting cathode may have a porosity in the range of 20%-85% as determined by mercury infiltration porosimetry. The porosity can be measured according to ASTM D4284-12 “Standard Test Method for Determining Pore Volume Distribution of Catalysts and Catalyst Carriers by Mercury Intrusion Porosimetry” using the version as of the date of the filing of this application.

The cathode material 2 can be formed on a cathode current collector 1 formed from a conductive material that serves as an electrical connection between the cathode material and an external electrical connection or connections. In some embodiments, the cathode current collector 1 can be, for example, carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, half nickel and half copper, or any combination thereof. In some embodiments, the current collector 1 can comprise a carbon felt, carbon foam, a conductive polymer mesh, or any combination thereof. The cathode current collector may be formed into a mesh (e.g., an expanded mesh, woven mesh, etc.), perforated metal, foam, foil, felt, fibrous architecture, porous block architecture, perforated foil, wire screen, a wrapped assembly, or any combination thereof. In some embodiments, the current collector can be formed into or form a part of a pocket assembly, where the pocket can hold the cathode material 2 within the current collector 1. A tab (e.g., a portion of the cathode current collector 1 extending outside of the cathode material 2 as shown at the top of the cathode 12 in FIG. 1B) can be coupled to the current collector to provide an electrical connection between an external source and the current collector.

The cathode material 2 can be pressed onto the cathode current collector 1 to form the cathode 12. For example, the cathode material 2 can be adhered to the cathode current collector 1 by pressing at, for example, a pressure between 1,000 psi and 20,000 psi (between 6.9×10⁶ and 1.4×10⁸ Pascals). The cathode material 2 may be adhered to the cathode current collector 1 as a paste. The resulting cathode 12 can have a thickness of between about 0.1 mm to about 5 mm.

In some embodiments, the anode material 5 can comprise an electroactive material including, but not limited to, zinc, lithium, aluminum, magnesium, iron, cadmium, or a combination thereof. In some aspects, the anode electroactive material can comprise zinc (Zn). Zn can exist in powder form or as a metallic structure in the anode material 5. In some embodiments, the anode material 5 can comprise zinc metal, or zinc powders, zinc powders mixed with zinc oxide, or combinations thereof; and binder. The Zn powder can be of varying sizes ranging from nanometers to microns. The Zn metallic structure can be a foil, mesh, perforated foil, foam, sponge-type, or any combination thereof.

While the current disclosure is discussed in some portions in the context of a Zn anode, it should be understood that other anode electroactive materials (e.g., metals other than Zn) can be used to form a manganese dioxide battery. The cells as described herein can be formed by pairing of any of the cathode materials described herein and any of the anode materials as described to the extent that the materials mentioned above to generate a voltage in the presence of suitable electrolytes.

In an embodiment, an electrically conductive material may be optionally present in the anode material in an amount of from about 5 wt. % to about 20 wt. %, alternatively from about 5 wt. % to about 15 wt. %, or alternatively from about 5 wt. % to about 10 wt. %, based on the total weight of the anode material. As will be appreciated by one of skill in the art, and with the help of this disclosure, the electrically conductive material can be used in the anode mixture as a conducting agent, e.g., to enhance the overall electric conductivity of the anode mixture. Non-limiting examples of electrically conductive material suitable for use can include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof. In some embodiments, the electrically conductive material used in the anode mixture can comprise a metallic conductive powder, wherein the metallic conductive powder comprises copper, bismuth, indium, nickel, silver, tin, etc., or any combination thereof.

The anode material 5 may also comprise a binder. Generally, a binder functions to hold the electroactive material particles together and in contact with the current collector. The binder can be present in a concentration of 0-10 wt. %. The binders in the anode material 5 can also comprise any of the binders described herein with respect to the cathode material. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which can be used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be PTFE, which is a very resistive material, but its use in the industry has been widespread due to its good rollable properties. In some embodiments, the binder may be present in the anode material in an amount of from about 2 wt. % to about 10 wt. %, alternatively from about 2 wt. % to about 7 wt. %, or alternatively from about 4 wt. % to about 6 wt. %, based on the total weight of the anode material.

In some embodiments, the anode material 5 can be used by itself without a separate anode current collector 4, though a tab or other electrical connection can still be provided to the anode material 5. In this embodiment, the anode material may have the form or architecture of a foil, a mesh, a perforated layer, a foam, a felt, or a powder. For example, the anode can comprise a metal foil electrode, a mesh electrode, or a perforated metal foil electrode.

In some embodiments, the anode 13 can comprise an optional anode current collector 4. The anode current collector 4 can be used with an anode 13, including any of those described with respect to the cathode 12. The anode material 5 can be pressed onto the anode current collector 4 to form the anode 13. For example, the anode material 5 can be adhered to the anode current collector 4 by pressing at, for example, a pressure between 1,000 psi and 20,000 psi (between 6.9×10⁶ and 1.4×10⁸ Pascals). The anode material 5 may be adhered to the anode current collector 4 as a paste. A tab of the anode current collector 4, when present, can extend outside of the device to form the current collector tab. The resulting anode 13 can have a thickness of between about 0.1 mm to about 5 mm.

In some embodiments, the cathode material and the anode material with their corresponding electroactive materials can also be formed from dissolved salts in the corresponding electrolytes (e.g., catholyte and anolyte, respectively). The process of forming the cathode material and the anode material from dissolved salts in the corresponding electrolytes would involve a charging step or a formation step, where the dissolved salts containing the active ions are plated onto the current collector by electrons flowing from an outside circuit. For example, manganese salts like manganese sulfate, manganese triflate, etc. may electroplate MnO₂ during the charging or formation step. Similarly, zinc oxide dissolved into the anolyte will form Zn during the charging or formation step.

As disclosed herein, the cathode and anode materials can be adhered to the corresponding current collector by pressing at, for example, a pressure between 1,000 psi and 20,000 psi (between 6.9×10⁶ and 1.4×10⁸ Pascals). The cathode and anode materials may be adhered to the corresponding current collector as a paste. A tab of each current collector may extend outside of the device and cover less than 0.2% of the electrode area. In some embodiments, the cathode current collector and the anode current collector may be a conductive material, for example, nickel, nickel-coated steel, tin-coated steel, silver coated copper, copper plated nickel, nickel plated copper, copper or similar material. The cathode current collector and/or the anode current collector may be formed into an expanded mesh, perforated mesh, foil or a wrapped assembly.

In some embodiments, a separator 9 (e.g., as shown in FIG. 1C) and/or buffer layer can be disposed between the anode 13 and the cathode 12 when the electrodes are constructed into the battery. The separator (e.g., separator 9) clearly demarcates the cathode from the anode. While shown as being disposed between the anode 13 and the cathode 12, the separator 9 can be used to wrap one or more of the anode 13 and/or the cathode 12, or alternatively one or more anodes 13 and/or cathodes 12 when multiple anodes 13 and cathodes 12 are present.

The separator can comprise the ion selective layer as described herein. For example, the ion selective layer can comprise a water-soluble organic polymer, a cross-linker, and an optional a water-soluble inorganic salt or hydroxide. In some aspects, the ion selective layer can be formed as a freestanding layer or film. In some aspects, the freestanding layer or film can be formed into a roll and used in a roll based process where the different layers are brought together and formed into a cell. As used herein, the term freestanding refers to a layer or film that can be handled without breaking and without the use of a support layer or backing. In this respect, a freestanding layer is distinct from a coating or spray that requires another support structure to be handled and processed. Any of the ion selective layer(s) described herein can be used between the anode 13 and the cathode 12, and the ion selective layer(s) can be formed using any of the formation processes described herein.

In some aspects, the ion selective layer can be used with one or more separator layers. For example, when a separator is used in combination with the ion selective layer, between 1 to 5 layers of the separator can be applied between adjacent electrodes. The separator can be formed from a suitable material such as nylon, polyester, polyethylene, polypropylene, poly(tetrafluoroethylene) (PTFE), poly(vinyl chloride) (PVC), polyvinyl alcohol, cellulose, or any combination thereof. Suitable layers and separator forms can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water of the material used in the separator is less than 30°. In yet another embodiment, the contact angle with water of the material used in the separator is less than 20°. The polyolefin may be modified by, for example, the addition of TRITON X-100™ or oxygen plasma treatment. In some embodiment, the separator 9 may be a polymeric separator (e.g., cellophane, sintered polymer film, a hydrophilically modified polyolefin). In some embodiments, the separator 9 can comprise a CELGARD® brand microporous separator. In an embodiment, the separator 9 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, a water electrolysis membrane, a composite of polyvinyl alcohol and graphene oxide, polyvinyl alcohol, crosslinked polyvinyl alcohol, or a combination thereof.

In some embodiments, the separator used with the ion selective layer can comprise an ion-selective gel; wherein the ion-selective gel comprises an ionomer, a bipolar membrane, a cation-exchange membrane, an anion-exchange membrane, a cellophane grafted with ion-selective properties, a polymeric membrane, a polyvinyl alcohol grafted with ion-selective properties, a ceramic separator, an ion-selective ceramic separator, NaSiCON, LiSiCON, or any combination thereof. Cellulose-based membranes like cellophane can also be used as separators. Polymeric membranes having cation-exchange properties like Nafion and/or anion-exchange membranes can be used as separators. Polyvinyl alcohol (PVA) and/or cross-linked polyvinyl alcohol (C-PVA) can also be used as polymeric separators. The cellulose-based membranes, PVA, and C-PVA can be grafted with ionomers that may impart cation and/or anion exchange properties. Bipolar membranes can also be used as separators.

An electrolyte (e.g. an alkaline hydroxide, such as NaOH, KOH, LiOH, or mixtures thereof) can be contained within the free spaces of the electrodes 12, 13, the separator 9, and the housing 7. The electrolyte may have a concentration of between 5% and 50% w/w. The electrolyte can be in the form of a liquid and/or gel. For example, the battery 10 can comprise an electrolyte that can be gelled to form a semi-solid polymerized electrolyte. In some embodiments, the electrolyte can be an alkaline electrolyte. The alkaline electrolyte can be a hydroxide such as potassium hydroxide, sodium hydroxide, lithium hydroxide, ammonium hydroxide, cesium hydroxide, or any combination thereof. The resulting electrolyte can have a pH greater than 7, for example between 7 and 15.1. In some embodiments, the pH of the electrolyte can be greater than or equal to 10 and less than or equal to about 15.13.

Nonlimiting examples of alkaline electrolytes or ions having relatively high hydroxyl activity suitable for use in the electrolyte include ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof.

In some embodiments, the electrolyte can be an alkaline electrolyte. As disclosed herein, the alkaline electrolyte can be a hydroxide such as potassium hydroxide, sodium hydroxide, lithium hydroxide, ammonium hydroxide, cesium hydroxide, or any combination thereof. In some embodiments, the alkaline electrolyte can have a pH of greater than 7, alternatively equal to or greater than 8, alternatively equal to or greater than 9, alternatively equal to or greater than 10, alternatively equal to or greater than 11, or alternatively equal to or greater than 12, or alternatively equal to or greater than 13. In some embodiments, the pH of the anolyte can be greater than or equal to about 8 and less than or equal to about 15.13, alternatively greater than or equal to about 10 and less than or equal to about 15.13, alternatively greater than or equal to about 11 and less than or equal to about 15.13 alternatively greater than or equal to about 12 and less than or equal to about 15.13, or alternatively greater than or equal to about 13 and less than or equal to about 15.13.

In some embodiments, the electrolyte may comprise an alkaline hydroxide selected from the group consisting of sodium hydroxide, potassium hydroxide, cesium hydroxide, rubidium hydroxide, lithium hydroxide, and combinations thereof.

In addition to a hydroxide, the electrolyte can comprise additional components. In some embodiments, the alkaline electrolyte can have zinc oxide, potassium carbonate, potassium iodide, and/or potassium fluoride as additives. When zinc compounds are present in the electrolyte, the electrolyte can comprise zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, sodium hydroxide, potassium hydroxide, lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, acrylic acid, N,N′-Methylenebisacrylamide, potassium persulfate, ammonium persulfate, sodium persulfate, or a combination thereof.

In other embodiments, the electrolyte can be an aqueous solution having an acidic or neutral pH. When the electrolyte is acid, the electrolyte can comprise an acid such as a mineral acid (e.g., hydrochloric acid, nitric acid, sulfuric acid, etc.). In some embodiments, the electrolyte solution can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, zinc sulfate, zinc triflate, zinc acetate, zinc nitrate, bismuth chloride, bismuth nitrate, nitric acid, sulfuric acid, hydrochloric acid, sodium sulfate, potassium sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, or any combination thereof. In some embodiments, the electrolyte can be an acidic or neutral solution, and the pH of the electrolyte can be between 0 and 7.

In some embodiments, the pH of the electrolyte can be altered by using bases of different strengths, where the following from low to high strength can be used: ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof. While these examples of alkaline electrolytes can help alter hydroxyl activity, it should be apparent to anyone skilled in chemistry or electrochemistry that any combination of alkaline electrolytes and other electrolytes can be used to alter hydroxyl activity.

In some embodiments, the electrolyte can comprise electrolyte additives, such as vanillin, indium hydroxide, zinc acetate, zinc oxide, cetyltrimethylammonium bromide, sodium dodecyl sulfate, sodium dodecylbenzene sulfonate, polyethylene glycol, ethanol, methanol, zinc gluconate, glucose, or any combination thereof.

In some embodiments, an organic solvent containing a suitable salt can be used as an electrolyte. Examples of suitable organic solvents include, but are not limited to, cyclic carbonates, linear carbonates, dialkyl carbonates, aliphatic carboxylate esters, γ-lactones, linear ethers, cyclic ethers, aprotic organic solvents, fluorinated carboxylate esters, and combinations thereof. Any suitable additives including salts as described herein can be used with the organic solvents to form an organic electrolyte for the anolyte and/or catholyte.

In order to help impregnate the electrodes with the electrolyte, the electrodes can be pre-soaked with the selected electrolyte solution. This can be performed by soaking the electrodes in the electrolyte outside of the battery or housing, and then placing the pre-soaked electrodes into the housing to construct the battery. In some embodiments, an electrolyte can be introduced into the battery to soak the electrodes in-situ. This can include the use of a vacuum to assist in impregnating the electrodes. The electrodes can be soaked for between about 1 minute and 24 hours. In some embodiments, the soaking can be carried out over a plurality of cycles in which the battery is filled with the electrolyte and allowed to soak, drained, refilled and allowed to soak, followed by draining a desired number of times.

While described as having a single electrolyte, in some aspects, two separate electrolytes with different compositions can be used in a battery. The electrolyte in contact with the anode can be referred to as the anolyte, and the electrolyte in contact with the cathode can be referred to as the catholyte. The anolyte and catholyte can be separated by the ion selective layer and any addition separator layers. As shown in FIG. 1B, a catholyte 3 can be in contact with the cathode 12, and an anolyte 6 can be in contact with the anode 13. The catholyte 3 can be disposed in the housing 10 in contact with the cathode material 2. The anolyte 6 can be disposed in the housing 10 in contact with the anode material 5. In some embodiments, the catholyte 3 and the anolyte 6 can have substantially the same composition. For example, in some embodiments, both the catholyte 3 and the anolyte 6 can be liquid. In other embodiments, the catholyte 3 and the anolyte 6 can have different compositions. For example, in some embodiments, the anolyte 6 can be polymerized or gelled, and the catholyte 3 can be a liquid. As another example, in other embodiments, the catholyte 3 can be polymerized or gelled, and the anolyte 6 can be a liquid. The polymerization of the catholyte 3 and/or the anolyte 6 can prevent mixing between the catholyte 3 and the anolyte 6. In yet other embodiments, both the catholyte 3 and the anolyte 6 can be gelled. The catholyte 3 and the anolyte 6 can also comprise different pH values to provide a desired voltage output from the battery.

Once the battery is formed having at least one conductive interlayer disposed therein, the battery 10 can then be used in a primary or secondary battery. When used as a secondary battery, the battery 10 can be cycled during use by being charged and discharged. The cell can be cycled using any suitable cycling protocols. In some embodiments, the battery can be cycled under constant current conditions or a constant current cycling protocol. The use of a constant current cycling protocol can allow the cell to operate over a large voltage range than a typical constant voltage cycling protocol.

### EXAMPLES

The subject matter having been generally described, the following examples are given as particular aspects of the disclosure and are included to demonstrate the practice and advantages thereof, as well as preferred aspects and features of the inventions. It should be appreciated by those of skill in the art that the techniques disclosed in the examples which follow represent techniques discovered by the inventors to function well in the practice of the inventions, and thus can be considered to constitute preferred modes for its practice.

### Example 1

A PVA solution was prepared by dissolving solid PVA (Mw=146,000˜186,000, 99+% hydrolyzed) into deionized water with continuous stirring for 2 hours at 90° C. Big air bubbles were removed by bath sonication. The PVA membrane was prepared by pouring the 5 wt. % PVA solution into a Teflon tray and kept at room temperature overnight. A transparent homogenous film was peeled off the tray after drying. The cross-linked PVA membrane was similarly prepared by casting with the 5 wt. % PVA solution containing 0.125 wt. % Glutaraldehyde (GA) cross-linker. Cross-linking was achieved by the sulfuric acid catalyzed acetalization reaction.

The PVA and cross-linked PVA layers were characterized for the zincate permeabilities and the ionic conductivities. The zincate permeability was investigated by a two-chamber diffusion cell with a separator placed in between. The ionic conductivities of the separators were measured by an AC impedance method. FIG. 1 shows the results for each layer. It is found that PVA conducts OH⁻ ions better than the cross-linked PVA due to its good hydrophilicity and rich hydroxyl groups in the polymer structure, which strongly interact with water molecules and OH⁻ ions. However, the permeability to zincate ions is reduced to one order of magnitude lower by cross-linking the PVA as the movement of bulkier zincate ions is hindered by the randomly entangled polymer chains in the cross-linked PVA.

### Example 2

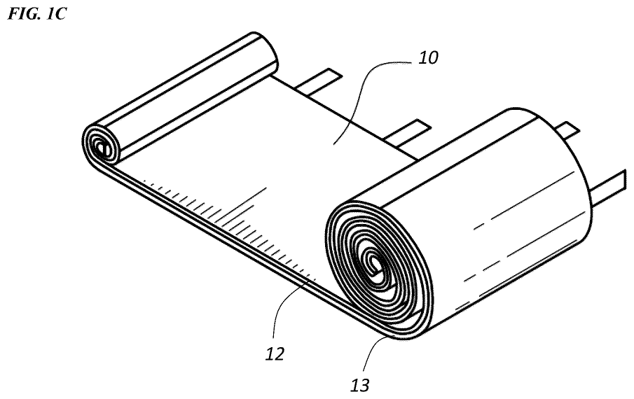

The effectiveness of cross-linking the PVA layer in suppressing the crossover of zincate ions was also evaluated by investigating its performance in the batteries. A rechargeable cell where a Bi/Cu modified EMD cathode was applied to cycle in its full 2-electron region was used for the deep cycling tests in the full 2-electron region of MnO₂. The specific charge and discharge capacities of cells with PVA and cross-linked PVA as a function of cycle life are shown in FIG. 2. The cell with a cross-linked PVA layer shows stable capacity for more than 100 cycles with near-full 2-electron capacity of MnO₂ achieved. A discharge capacity fade is observed in less than 20 cycles in the cell with PVA, while its charging capacity remains unchanged, leading to overcharge of the cell. This phenomenon is a clear sign of short circuit, which is usually caused by Zn dendrites penetrating the separators and the copper materials from the cathodes deposited onto the anode.

### Example 3

A cross-linked polyacrylate-KOH-H₂O layer was prepared from a mixed solution of acrylic acid and potassium hydroxide (KOH). The concentration of KOH was 37 wt %. 0.02 wt % K₂S₂O₈ was used as the initiator and 0.06 wt % N,N′methylene-bisacrylamide (MBA) was used as the cross-linker.

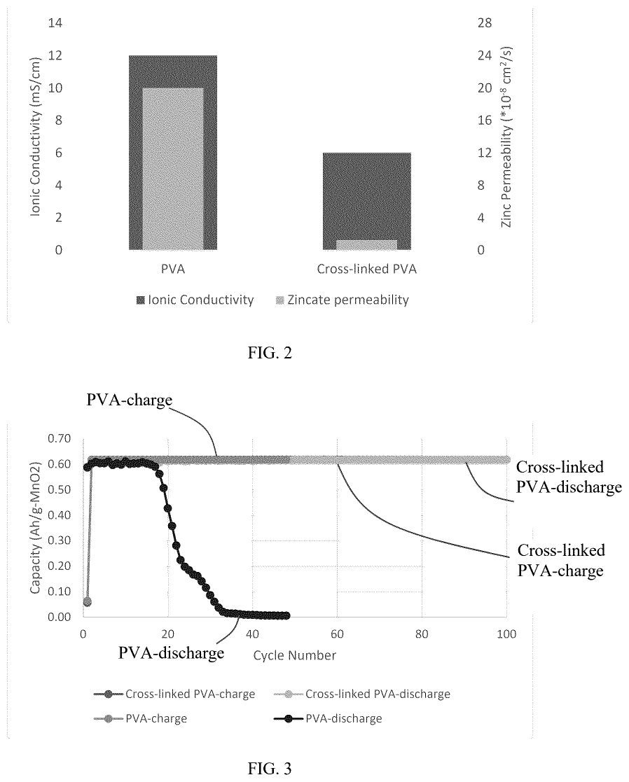

Cycle life tests were conducted by running cells at shallow depth of discharge in the 1^{st} electron region of MnO₂. FIG. 3 shows the specific charge and discharge capacity with and without the cross-linked polyacrylate-KOH-H₂O layer. It is found that the cell with the cross-linked polyarylate-KOH-H₂O layer cycles for more than 500 cycles with little capacity fade. The control cell starts to show discharge capacity fade much earlier after 120 cycles while its charging capacity remains unchanged, leading to overcharge of the cell. This phenomenon is a clear sign of short circuit, which is usually caused by Zn dendrites penetrating the separators.

### Additional Disclosure

The following is provided as additional disclosure for combinations of features and aspects of the presently disclosed subject matter.

In a first aspect, an ion selective layer comprises a water-soluble organic polymer; a cross-linker; a water-soluble inorganic salt or hydroxide; and water.

A second aspect can include the ion selective layer of the first aspect, wherein the water-soluble organic polymer can be poly(vinyl alcohol), poly(acrylic acid), poly(ethylene glycol), polyacrylamide, cellulose, poly(methacrylic acid), or combinations thereof.

A third aspect can include the ion selective layer of the first or second aspect, wherein the water-soluble organic polymer is cross-linked.

A fourth aspect can include the ion selective layer of any one of the first to third aspects, wherein the water-soluble organic polymer is cross-linked with organic dialdehyde, N,N′methylene-bisacrylamide, boric acid, sodium borate, or combinations thereof.

A fifth aspect can include the ion selective layer of any one of the first to fourth aspects, wherein the water-soluble organic polymer has an average molecular weight of 500 to 200,000 Da.

A sixth aspect can include the ion selective layer of any one of the first to fifth aspects, wherein the weight ratio of water to the water-soluble organic polymer is in the range of 0 to 10.

A seventh aspect can include the ion selective layer of any one of the first to sixth aspects, wherein the weight ratio of the water-soluble inorganic salt or hydroxide to the water-soluble organic polymer is in the range of 0 to 10.

An eighth aspect can include the ion selective layer of any one of the first to seventh aspects, wherein the weight ratio of water to the water-soluble inorganic salt or hydroxide is in the range of 0 to 20.

A ninth aspect can include the ion selective layer of any one of the first to eighth aspects, wherein the weight ratio of crosslinker to the water-soluble organic polymer is in the range of 0.0001 to 0.1.

A tenth aspect can include the ion selective layer of any one of the first to ninth aspects, wherein the water-soluble inorganic salt or hydroxide can be potassium carbonate, sodium carbonate, potassium sulfate, sodium sulfate, potassium chloride, sodium chloride, potassium fluoride, sodium fluoride, potassium hydroxide, sodium hydroxide, lithium hydroxide, or combinations thereof.

An eleventh aspect can include the ion selective layer of any one of the first to tenth aspects, wherein the thickness of the layer ranges from 10 μm to 10 mm.

In a twelfth aspect, a method of making the ion selective layer of the first aspect comprises: dissolving a water-soluble organic polymer in water; dissolving a water-soluble inorganic salt or hydroxide in water; dissolving a cross-linker in water; cross-linking the water soluble polymer; forming a layer by casting onto a substrate; and drying the water solution to form a freestanding film.

In a thirteenth aspect, a method of making the ion selective layer of the first aspect comprises: dissolving a water-soluble organic monomer in water; dissolving a water-soluble inorganic salt or hydroxide in water; dissolving a cross-linker in water; dissolving an initiator in water; polymerizing and cross-linking the water-soluble monomer; forming a layer by casting onto a substrate; and drying the water solution to desired water content.

A fourteenth aspect can include the method of the twelfth aspect, wherein the organic polymer is dissolved in water under rigorous stirring at temperatures ranging from 20-100° C.

A fifteenth aspect can include the method of the thirteenth aspect, wherein the organic monomer is dissolved in water under rigorous stirring at temperatures ranging from 20-100° C.

A sixteenth aspect can include the method of any one of the twelfth to fifteenth aspects, wherein the ion selective layer is air dried at temperatures ranging from 20-100° C.

A seventeenth aspect can include the method of the thirteenth aspect, wherein the initiator can be peroxides or aliphatic azo compounds, or combinations thereof.

In an eighteenth aspect, an alkaline battery comprises: an anode; a cathode; an electrolyte; and a separator disposed between the anode and the cathode.

A nineteenth aspect can include the alkaline battery of the eighteenth aspect, wherein the battery is a primary battery or a rechargeable battery.

A twentieth aspect can include the alkaline battery of the eighteenth or nineteenth aspect, wherein the separator comprises at least one ion selective layer in claim 1.

A twenty first aspect can include the alkaline battery of any one of the eighteenth to twentieth aspects, wherein the ion selective layer is applied alone or combined with one or more non-selective separator membranes.

A twenty second aspect can include the alkaline battery of any one of the eighteenth to twenty first aspects, wherein the non-selective membranes can be nonwovens or polymer films fabricated from nylon, polyester, polyethylene, polypropylene, poly(tetrafluoroethylene)(PTFE), poly(vinyl chloride) (PVC), polyvinyl alcohol, cellulose and combinations thereof.

A twenty third aspect can include the alkaline battery of any one of the eighteenth to twenty second aspects, wherein the anode can be zinc, lithium, aluminum, magnesium, iron, cadmium, or a combination thereof.

A twenty fourth aspect can include the alkaline battery of any one of the eighteenth to twenty third aspects, wherein the cathode can be metal oxide or metal hydroxide of manganese, nickel, silver, lead, copper, or combinations thereof.

A twenty fifth aspect can include the alkaline battery of any one of the eighteenth to twenty fourth aspects, wherein the electrolyte can be solution of potassium hydroxide, sodium hydroxide, lithium hydroxide and combinations thereof, with a concentration between 5-50 wt %.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. An ion selective layer comprising:
a water-soluble organic polymer;
a cross-linker;
a water-soluble inorganic salt or hydroxide; and
water.

2. The ion selective layer of claim 1, wherein the water-soluble organic polymer comprises poly(vinyl alcohol), poly(acrylic acid), poly(ethylene glycol), polyacrylamide, cellulose, poly(methacrylic acid), or combinations thereof.

3. The ion selective layer of claim 1, wherein the water-soluble organic polymer is cross-linked.

4. The ion selective layer of claim 1, wherein the water-soluble organic polymer is cross-linked with organic dialdehyde, N,N′methylene-bisacrylamide, boric acid, sodium borate, or combinations thereof.

5. The ion selective layer of claim 1, wherein the water-soluble organic polymer has an average molecular weight of 500 to 200,000 Da.

6. The ion selective layer of claim 1, wherein the weight ratio of water to the water-soluble organic polymer is in the range of 0 to 10.

7. The ion selective layer of claim 1, wherein the weight ratio of the water-soluble inorganic salt or hydroxide to the water-soluble organic polymer is in the range of 0 to 10.

8. The ion selective layer of claim 1, wherein the weight ratio of water to the water-soluble inorganic salt or hydroxide is in the range of 0 to 20.

9. The ion selective layer of claim 1, wherein the weight ratio of crosslinker to the water-soluble organic polymer is in the range of 0.0001 to 0.1.

10. The ion selective layer of claim 1, wherein the water-soluble inorganic salt or hydroxide comprises potassium carbonate, sodium carbonate, potassium sulfate, sodium sulfate, potassium chloride, sodium chloride, potassium fluoride, sodium fluoride, potassium hydroxide, sodium hydroxide, lithium hydroxide, or combinations thereof.

11. The ion selective layer of claim 1, wherein the thickness of the layer ranges from 10 μm to 10 mm.

12. A method of making the ion selective layer, the method comprising:
dissolving a water-soluble organic polymer in water,
dissolving a water-soluble inorganic salt or hydroxide in water,
dissolving a cross-linker in water,
cross-linking the water-soluble polymer,
forming a layer by casting onto a substrate; and
drying the water solution to form a film.

13. The method of claim 12, wherein the organic polymer is dissolved in water under rigorous stirring at temperatures ranging from 20-100° C.

14. A method of making the ion selective layer, the method comprising:
dissolving a water-soluble organic monomer in water;
dissolving a water-soluble inorganic salt or hydroxide in water;
dissolving a cross-linker in water;
dissolving an initiator in water;
polymerizing and cross-linking the water-soluble monomer;
forming a layer by casting onto a substrate; and
drying the water solution to form a film.

15. The method of claim 14, wherein the organic monomer is dissolved in water under rigorous stirring at temperatures ranging from 20-100° C.

16. The method of claim 14, wherein the ion selective layer is air dried at temperatures ranging from 20-100° C.

17. The method of claim 14, wherein the initiator comprises peroxides or aliphatic azo compounds or combinations thereof.

18. An alkaline battery comprising:
an anode;
a cathode;
an electrolyte; and
an ion selective layer disposed between the anode and the cathode, wherein the ion selective
layer comprises:
a water-soluble organic polymer;
a cross-linker;
a water-soluble inorganic salt or hydroxide; and
water.

19. The alkaline battery of claim 18, wherein the battery is a primary battery or a rechargeable battery.

20. The alkaline battery of claim 18, wherein the ion selective layer is applied alone or combined with one or more non-selective separator membranes.

21. The alkaline battery of claim 18, wherein the non-selective membranes comprises nonwovens or polymer films fabricated from nylon, polyester, polyethylene, polypropylene, poly(tetrafluoroethylene)(PTFE), poly(vinyl chloride) (PVC), polyvinyl alcohol, cellulose and combinations thereof.

22. The alkaline battery of claim 18, wherein the anode comprises zinc, lithium, aluminum, magnesium, iron, cadmium, or a combination thereof.

23. The alkaline battery of claim 18, wherein the cathode comprises a metal oxide or metal hydroxide of manganese, nickel, silver, lead, copper, or combinations thereof.

24. The alkaline battery of claim 18, wherein the electrolyte comprises a solution of potassium hydroxide, sodium hydroxide, lithium hydroxide and combinations thereof, with a concentration between 5-50 wt %.
